(19) United States
(12) Patent Application Publication
(10) Pub. No.: US 2005/0160409 A1
(43) Pub. Date: Jul. 21, 2005

(54) Systems and methods for providing software and a corresponding pricing model

(76) Inventors: Veronika Schmid-Lutz, Ittlingen (DE); Jurgen Remmel, Muhlhausen (DE); Rainer Feser-Tehranian, Waldsee (DE); Michael Franz, Angelbachtal (DE); Stefan Weisenberger, Heidelberg (DE); Stefan Schaffer, Eggenstein (DE); Robert Cummings, Wiesloch (DE); Oliver Sievi, Sandhausen (DE); Ralf Strassner, Kolbermoor (DE); Claus Heinrich, Heidelberg (DE); Andreas Simon Schmitt, Kaiserslauten (DE)

Correspondence Address: Finnegan, Henderson, Farabow,;Garrett & Dunner, L.L.P., 1300 I Street, N.W., Washington, DC, 20005-3315, US

(21) Appl. No.: 10/845,184

(22) Filed: May 14, 2004

Related U.S. Application Data
(60) Provisional application No. 60/470,428, filed on May 15, 2003.

(51) Int. Cl. G06F 9/45

(52) U.S. Cl. 717/140; 717/121

(57) ABSTRACT

Systems and methods are provided for configuring software based on the selection of extensions and/or business sets and functions by a user. IA method for configuring software based on the user selection of extensions includes presenting extensions for selection by a user and determining whether the user selection of the extensions is valid. The method further includes performing updates to source code based on the user selection of the extensions and compiling the source code corresponding to the selected extensions to generate a user-specific system.

### CROSS REFERENCE TO RELATED APPLICATIONS

This application claims the priority under 35 U.S.C. § 119 of U.S. Provisional Application No. 60/470,428, filed May 15, 2003, the disclosure of which is expressly incorporated herein by reference in its entirety.

### BACKGROUND INFORMATION

1. Field of the Invention

The present invention generally relates to software and to systems and methods for providing and/or distributing software, including complex software. More particularly, the invention relates to systems and methods for providing software and a corresponding pricing model that is dependent on the software provided to each user.

2. Background of the Invention

In today's marketplace, software developers and vendors offer various types applications and programs to members of the public. Software applications and programs are often designed with a specific set of functionality and offered as a complete package. Many times, users are faced with the dilemma of selecting software that best fits their needs. In some cases, a certain application or program may include more components or functions than is required by the user. In other cases, a particular software program may not have all of the required functionality and, as a result, the user may be forced to purchase more than one application in order to fulfill his or her needs.

For more complex software, such as enterprise resource planning software and other business applications, some flexibility is often provided to users. For example, software vendors may permit their customers to adapt or customize the software they purchase to better meet their business needs or requirements. However, despite this flexibility, customers are normally restricted by the number or types of changes that can made to the software. Further, in many cases, developers of such software will only offer their software in limited packages with corresponding prices. Thus, in the case of complex software, business entities and other users may also be forced to purchase functionality and/or features that they may not have any use for.

By way of example, a small business may not need all of the functionality associated with an enterprise resource planning or supply chain management software package. However, if all of that functionality is included in the software, then the small business has no choice but to pay for that functionality even though only certain core features are needed. In other cases, the software may not have the specific functionality or features that would meet the customer's industry needs. These and other problems can arise due to the-difficulty of tailoring industry specific functionality into a one-size fits all type of package.

Software purchased with un-needed functionality or features can waste a customer's resources. For example, upon installation of such software at the customer's premises, database tables and other components may be installed at the customer site and consume disk space, which may never be used by the customer and could be applied more productively for other uses. Also, screen elements and other features included with the software may never be used by the customer and, as a result, hinder efficient use of the software.

Moreover, this rigidity in packaging and distributing software can result in inefficiencies for software developers and vendors. For instance, software providers may not be able to effectively sell their software to customers, because the price of the software may be deemed too high for the features and functionality ultimately used by the customer. This problem can be particularly acute for complex software, where the price for the software is often much higher than the average, off-the-shelf program or commercial offering.

Accordingly, in view of the foregoing, there is a need for systems and methods for providing software that overcomes one or more of the above-noted problems or disadvantages.

### SUMMARY OF THE INVENTION

Embodiments consistent with the present invention provide improved systems and methods for packaging and/or offering software. In accordance with one aspect of the invention, the software may correspond to any type of application or package, including complex software packages. Further, a pricing model may be utilized whereby the software is offered and/or distribute at a price that corresponds to the functions and/or features selected by a user.

According to one embodiment of the invention, a core layer of a complex software package may provide various functions in combination with extensions, such as software-based extensions. Extensions may relate to sub-system capabilities for an industry, such as banking and automotive, or may relate to specific functional areas, such as supply chain management or financial management. By selectively activating the relevant functionality through the extensions, a software vendor can configure a complex software system based on a user's selections. Further, based on the selected extensions, a price can also be determined for offering and/or distributing the software.

In accordance with an embodiment of the invention, a method for configuring software based on a user selection of extensions is provided. The method may include presenting extensions for selection by a user. The method may further include determining whether the selection of extensions by the user is valid and, if the user selection is determined to be valid, performing updates to source code for the software based on the user selection of extensions. The method may further include compiling the source code corresponding to the selected extensions and for a core layer of the software to generate a user-specific system.

According to another embodiment of the invention, a system is provided for distributing software. The systems may comprise: means for presenting extensions for selection by a user; means for determining whether the user selection of extensions is valid; means for determining, if the user selection is determined valid, a price for the software with the user selection of extensions; and means for offering or distributing the software to the user at the determined price.

In accordance with still another embodiment of the invention, a method is provided for configuring software based on a user selection of a business set and a corresponding set of functions. The method may include presenting a plurality of business sets for selection by a user and, based on a business set selected by the user, presenting functions associated with that business set for selection by the user. The method may further include determining whether the user selection of functions is valid and, if the user selection is determined to be valid, configuring the source code according the selections made by the user. Additionally, or alternatively, the method may include compiling the source code corresponding to the selected business set and functions by the user.

Additional objects and advantages of the various embodiments of the invention will be set forth in part in the description, or may be learned by practice of the invention. The objects and advantages of the embodiments of the invention will be realized and attained by means of the elements and combinations particularly pointed out in the appended claims.

The various embodiments can include and/or exclude different aspects, features and/or advantages, where applicable. In addition, various embodiments can combine one or more aspects or features of other embodiments, where applicable.

It is to be understood that both the foregoing general description and the following detailed description are exemplary and explanatory only and are not restrictive of the invention, as claimed.

### BRIEF DESCRIPTION OF THE DRAWINGS

It is to be understood that both the foregoing general description and the following detailed description are exemplary and explanatory only and are not restrictive of the invention, as claimed. The accompanying drawings, which are incorporated in and constitute a part of this specification, illustrate several embodiments of the invention and together with the description, serve to explain the principles of the invention. In the drawings:

FIG. 1 is a block diagram of an exemplary software system that includes extensions, consistent with an embodiment of the present invention;

FIG. 2 is a flow chart of an exemplary method for offering software to a user, consistent with an embodiment of the present invention;

FIG. 3 is a flow chart of an exemplary method for pricing software, consistent with an embodiment of the present invention;

FIG. 4A is a block diagram of another exemplary software system that includes industry extensions, consistent with an embodiment of the present invention;

FIG. 4B is a block diagram of exemplary business sets, consistent with an embodiment of the present invention;

FIGS. 5A-C illustrate exemplary interfaces for receiving user selections to configure software, consistent with embodiments of the present invention;

FIG. 6 is a flow chart of another exemplary method for offering software to a user, consistent with an embodiment of the present invention; and

FIG. 7 is a flow chart of another exemplary method for pricing software, consistent with an embodiment of the present invention.

### DETAILED DESCRIPTION

The following detailed description of embodiments of the present invention refers to the accompanying drawings. Where appropriate, the same reference numbers in different drawings refer to the same or similar elements.

Systems and methods consistent with the present invention relate to providing software. The invention also relates to offering or distributing software according to a pricing model that is dependent on selections made by a customer or user. As disclosed herein, embodiments of the invention may be implemented to offer various types of software, including complex software. For example, in accordance with an embodiment of the invention, a complex software package may be offered that includes a core layer. The core may include core functions and features that can be combined with extensions, such as software extensions. Extensions may relate to sub-system and/or specific capabilities for an industry, such as banking and automotive, or may relate to additional functionality and/or features that are not otherwise provided by the core. By selectively activating the extensions, a software vendor or seller can configure a complex software system based on a user's specific needs. Activation of the selected extensions may result in relevant functionality and/or features (e.g., screen elements, menu screens, data fields, etc.) being automatically configured for the selected extensions. Further, based on the extensions selected by a user, an appropriate price can also be determined for selling, licensing or otherwise providing the complex software to the user.

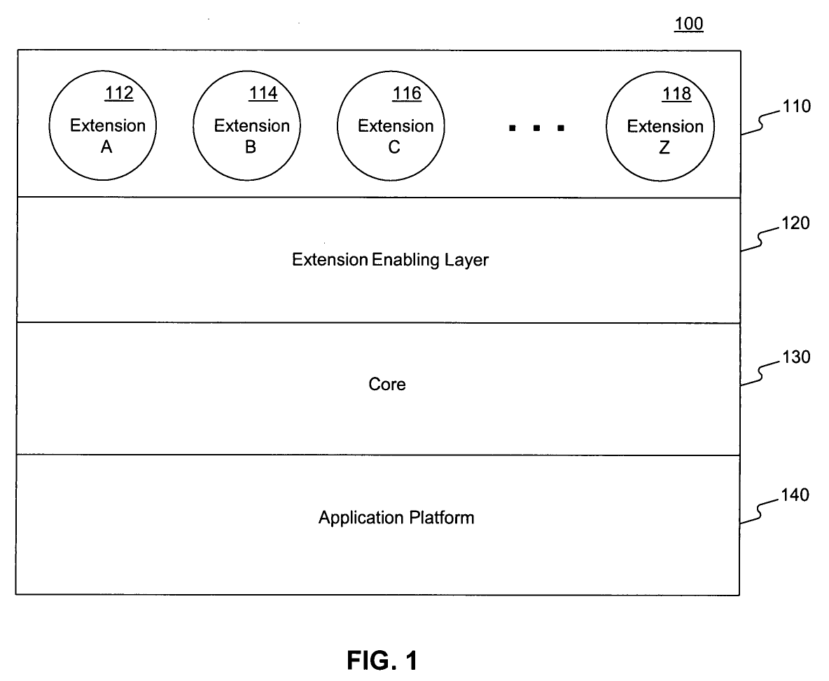

Referring to FIG. 1, a block diagram of an exemplary software system is shown, consistent with an embodiment of the invention. The example of FIG. 1 relates to a complex software system 100, such as an enterprise resource planning system or advanced planning system. As disclosed herein, software system 100 may be considered “complex” since it includes a number of software elements or components. These components are organized and illustrated as different layers in FIG. 1. As will be appreciated by those skilled in the art, embodiments of the invention are not limited to providing complex software (such as that illustrated in FIG. 1), but may also be applied for providing other types of software packages or systems.

Complex software system 100 may include a set of selectable extensions 110, an extension enabling layer 120, a core layer 130, and an application platform 140. In accordance with an aspect of the invention, these software elements or components may interact with and/or be dependent upon one another. As shown in FIG. 1, extensions 110 may include a plurality of selectable extensions, including an extension A 112, an extension B 114, an extension C 116, and an extension Z 118. Each extension may relate to a complete software package or set of functionality and/or features that can be combined with or modify the functionality and/or features of core layer 130. In one embodiment, extensions may relate to SAP Enterprise Core Component (ECC) available from SAP AG (Walldorf, Germany).

Extension enabling layer 120 may facilitate the enablement of extensions 112-118 according to a user's selection. In addition, extension enabling layer 120 may record or track the extensions selected by a user. This may be achieved by, for example, a registration table or other database tables or storage means. Where appropriate, extension enabling layer may also evaluate a user selection to determine if a set of selected extensions is valid. In one embodiment, this may be achieved through software-based logic or an appropriate algorithm. In another embodiment, the validity of selections may be determined by comparing a user selection to a look-up table or other storage means that indicates valid combinations of extensions. Whether or not a particular set of extensions is “valid” may rest upon on one or more factors, such as the interoperability or dependency of the extensions alone, in combination with other selected extension(s), and/or relative to other software layers (such as core layer 130). If a user selection is determined to be valid, extension enabling layer 120 may activate the selected extensions by including or enabling the same within the source code or compiled code delivered to the user. Further, any non-selected extensions may be left inactive or non-enabled in the software delivered to the user.

Core layer 130 may correspond to core software components or applications for complex software system 100. Core layer 130 may provide core functionality and/or features that are not particularized or embodied for any specific industry group, function group or custom group. Additionally, or alternatively, core layer 130 may include functionality that can be shared by extensions 112-118 of complex software system 100. By way of example, core layer 130 may be implemented with a core system such as the R/3 system, available from SAP AG (Walldorf, Germany).

Application platform 140 may comprise a software platform for supporting the various other layers of complex software system 100, including core layer 130. Such a software platform may comprise software (such as system operating software, portal software, database software, etc.) either alone or in combination with suitable hardware (such as a computing platform, a server, memory, etc.). In one embodiment, application platform 140 may include a web server, a business warehouse, and an enterprise portal. By way of example, application platform 140 may be implemented with SAP Netweaver, which is commercially available from SAP AG.

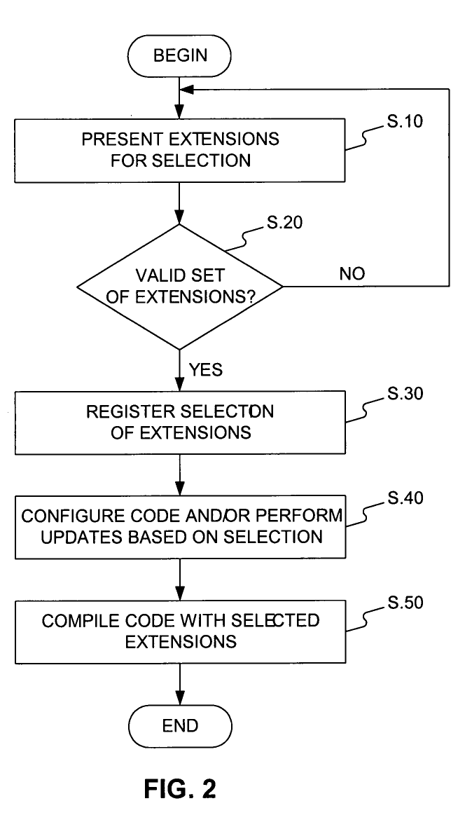

FIG. 2 illustrates a flow chart of an exemplary method for configuring software, consistent with an embodiment of the invention. The exemplary method of FIG. 2 may be applied to offer any type of software, including complex software 100 of FIG. 1. Further, in accordance with an aspect of the invention, the method of FIG. 2 may be automated by using a software component, such as enabling extension layer 120.

As shown in FIG. 2,the process may begin at step S.10, where extensions for selection are presented or displayed to a user. The extensions presented for selection may be any subset or set of extensions, such as extensions 110 of FIG. 1. In one embodiment, the extensions may be presented for selection through a graphical user interface, an email, orally and/or other communication means. In the case of a graphical user interface, the user may be presented with a list of available extensions for selection. As stated above, these extensions may be related to an industry group, a functional group, or a custom group. A short description of each extension may be provided to the user through, for example, a link, an attachment or upon request. Such a description may provide an overview of the functions or features associated with an extension and aid the user in making his/her selection. Entry of a user selection may be carried out through an input device, such as a keyboard, a mouse, reply email, orally, etc. Each user selection may be forwarded to extension enabling layer 120 (see FIG. 1) for processing and analysis. Additionally or alternatively, the user selection may be received and analyzed by core layer 130.

In step S.20, extension enabling layer 120 may determine whether the user selection of the extensions is valid. In one embodiment, this step may include detecting any conflicts among the selected extensions. Extension enabling layer 120 may detect conflicts by applying logic or a suitable algorithm. In one embodiment, extension enabling layer 120 may access one or more tables that indicate permissible combinations of extensions. Conflicts between selected extensions may relate to, for example, incompatible or unsupported combinations of extensions. Invalid extension selections may also arise if it is determined that any two selected extensions will result, for example, in attempts to modify or call the same data or system components at substantially the same time. In one embodiment, such conflicts may be known or determined based on analysis of various configurations of extensions 110.

If the selection of extensions is determined not to be valid (step S.20; No), then the process may return to step S.10 where the user is again prompted to make a selection. As part of this step, the user may be informed of his/her selection was determined to be invalid. Additionally, or alternatively, in one embodiment, extension enabling layer 120 may propose at least one alternative or additional extension to the user, such that the conflict among the extensions can be resolved by selecting that extension.

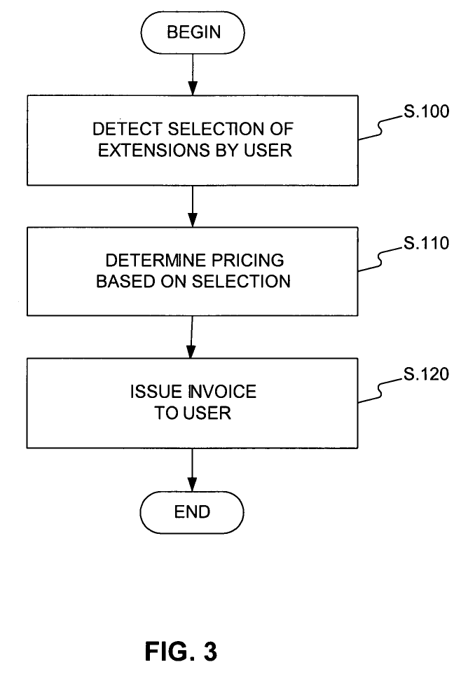

If the user selection is determined to be valid (step S.20; Yes), then processing may continue. As shown in FIG. 2, at step S.30, the user selection of extensions may be registered or recorded. This step may be necessary in order to later determine pricing for the software and/or configure the software for delivery to the user in accordance with the extensions selected (see, for example, FIG. 3). Alternatively, step S.30 may be made optional and not included in the process flow of FIG. 2.

In one embodiment, the user-selected extensions may be registered and reported through a software-based, reporting agent. In such a case, the reporting agent may be provided as part of extension enabling layer 120 or otherwise within system 100 to record valid user selections. When called, the reporting agent may access one or more database tables, such as a registration table, and report the user selection. Such a report may take the form of any suitable output (e.g., a printed report, a display output, a file output, etc.). Further, the reporting agent may be called at anytime to permit access to the user selection information by a software vendor, even after installation of the software at a customer's premises.

In step S.40, extension enabling layer 120 or similar logic may configure and/or perform updates to source code, for example, based on the user selection of extensions. Thus, for example, tables and/or other data storage elements may be updated to configure the original source code according to the user selection. Such updates may be made to activate the extensions selected by the user. Updates may be required throughout the code for one or more layers of the complex software system 100. Any extensions that are not selected by a user may be left inactive or completely removed from the source code.

Thereafter, in step S.50, the configured source code may be compiled to generate a user-specific system. In one embodiment, only the selected extensions may be operable in the software shipped to the user. The other remaining extensions in the set of extensions may not be made operable or, as indicated above, not included in the code. Thus, once configured and shipped to the user, the user may not access or use unselected extensions from the set of extensions 110. In such case, extension enabling layer 120 or other logic may keep track of selected and non-selected extensions and prevent the user from accessing functionality related to the non-selected extensions.

In accordance with an embodiment of the invention, a user may be permitted change the selection of extensions after delivery of the software. For example, after the user-specific system has been shipped to the user, the user may be able to request additional extensions or otherwise modify the selection of extensions. For this purpose, the reporting agent may keep track of such requests and based on a pre-agreed policy, the source code may be reconfigured and compiled so that the newly selected extensions are activated once the user has paid for them. An administrator code, password and/or key may be required to perform such an update on the software. The updates may be made either remotely by the software vendor or at the user's location. In one embodiment, requested extensions may be activated by extension enabling layer 120 upon receiving the request for them and the seller of the system may invoice the user, once the software vendor receives a report regarding the additional extensions from the reporting agent.

FIG. 3 is a flow chart of an exemplary method for determining pricing for software, consistent with an embodiment of the invention. The embodiment of FIG. 3 may be used in combination with the exemplary process of FIG. 2 to determine pricing after configuring the user-specific system.

In step S.100, the selection of extensions by the user is detected. By way of example, this step may be performed by extension enabling layer 120 or a suitable pricing module that is internal or external to complex software system 100 (FIG. 1). In either case, step S.100 as well as steps S.110 and S.120 may be executed by a computer (not shown) to perform the exemplary process of FIG. 3.

To detect the selection of extensions by the user (step S.100), extension enabling layer or a pricing module may access one or more database tables. For example, a registration table or other suitable database table(s) may be accessed that contain a record of the user selection of extensions (registered, for example, as part of step S.30 of FIG. 2).

Instep S.100, pricing for the software is determined based on the detected user selection. In one embodiment, pricing for the user-specific system (such as complex software system 100) may be generated based a predetermined pricing model. For example, a pricing model may be provided that combines a predetermined, base price for core layer 130, application platform 140, etc. with a certain price for the user-selected extensions. The total price may represent a software license fee or other price for any period of permitted use, such one month, six months, one year, or longer. If needed, invoices may be issued periodically to the user (e.g., monthly, annually, etc.).

The base price for the software may depend on the number of users that will use complex software system 100, for example. The price for user-selected extensions maybe based on the number of users who will be using the extensions concurrently, for example. The price for the selected extensions may increase depending on the total number of extensions selected by the user. In this manner, the user would pay only for the functionality that the user desires. Further, even if complex software system 100 is shipped with code for inactive extensions, the user would not be forced to pay extra for that unused code and functionality.

Referring again to FIG. 3, after pricing for the software is determined (step S.110), an invoice for the software may be issued to the user at step S.120. This step may be performed by, for example, a pricing module, alone or in combination, with other invoicing systems. Such an invoice may be mailed or electronically sent to the user. The invoice may include the pricing for the software and, optionally, identification of the extensions selected by the user. Consistent with embodiments of the invention, invoicing may be performed at any time, including prior to, concurrently with, or after delivery of the software to the user. Delivery of the software may also be achieved by any means, such as manually, electronically or via a network.

In one embodiment, subsequent to the purchase of complex software system 100, the user may be permitted to modify the selected extensions by, for example, adding or deleting extensions. For example, upon receiving the request to modify the extensions, the software vendor seller may remotely activate additional extensions, deactivate extensions, and/or otherwise modify the extension. Alternatively, the user may be shipped a new compiled version of the code based on the updated selection of extensions. Based on the updated set of enabled extensions, a new invoice may be issued to the user.

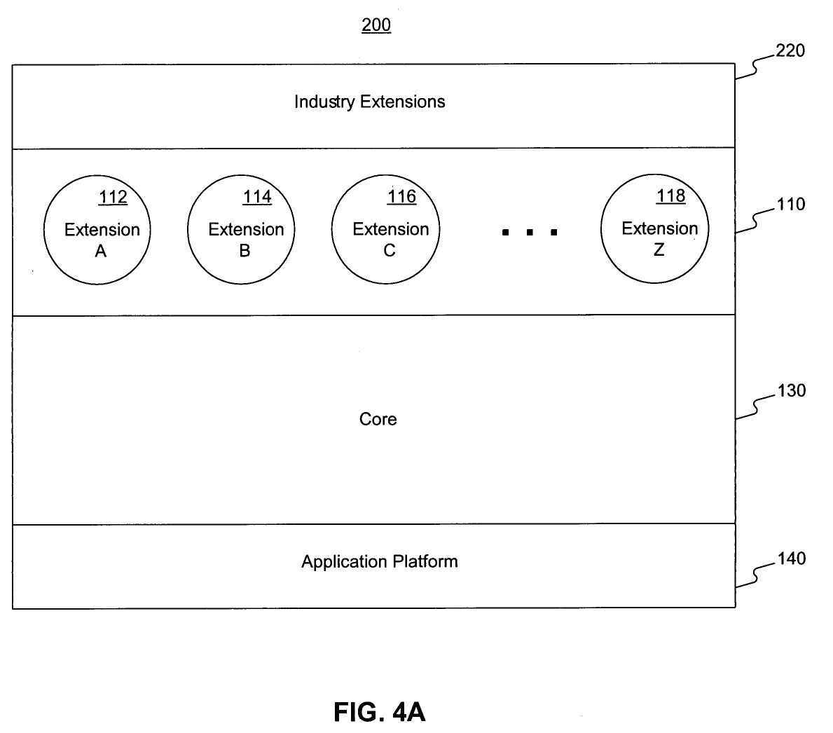

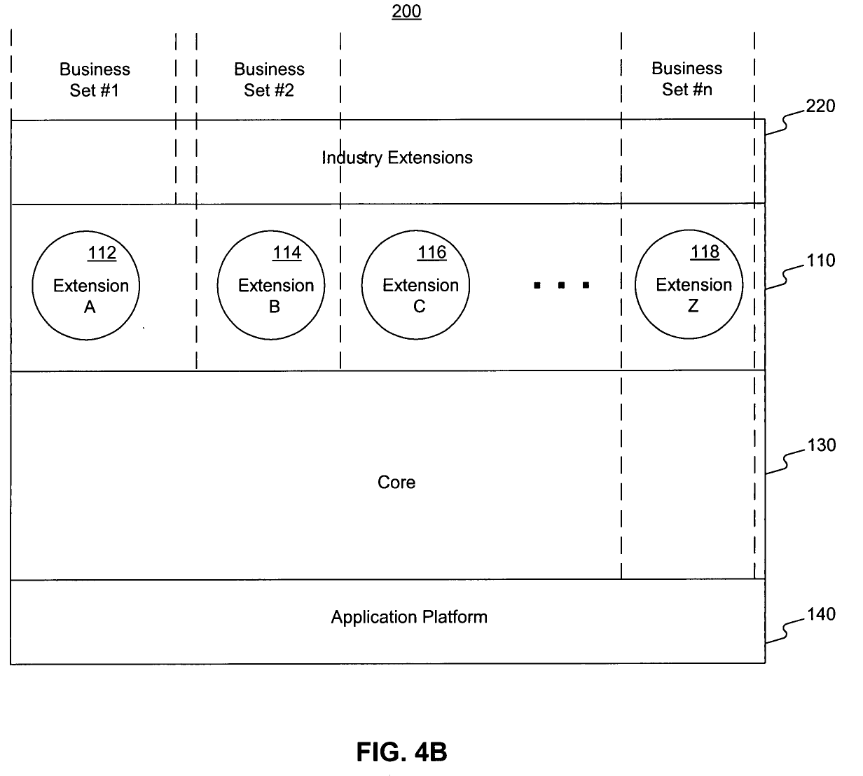

FIG. 4A illustrates is a block diagram of another exemplary software system that includes a set of industry extensions, consistent with an embodiment of the present invention. As shown in FIG. 4, complex software system 200 may be provided that includes a set of extensions 110, a core layer 130, an application platform 140, and industry extensions 220. In one embodiment, industry extensions 220 may represent extensions for specific industries and, unlike the set of extensions 110, may not be complete software packages. Instead, industry extensions 220 may be specific functionality or features (e.g., screen elements, menu screens, data fields, etc.) that modify, add, and/or delete aspects of extensions 110, for example. Alternatively, or additionally, industry extensions 220 may modify, add, and/or delete aspects of other layers of system 200, such as core layer 130 and application platform 140.

FIG. 4B illustrates is a block diagram of exemplary business sets, consistent with an embodiment of the present invention. In this figure, complex software system 200 is shown with a plurality of business sets #1-#n (represented by dashed-lines and superimposed on the layers for illustrative purposes). Business sets may represent sets of selectable functionality and/or features (e.g., screen elements, menu screens, data fields, etc.). The selectable functionality and/or features of the business sets (collectively referred below as “functions”) may extend to or impact on any combination functionality and/or features of one or more layers of system 200, including application layer 140, core layer 130, set of extensions 110, and/or industry extensions 220. As further disclosed herein, business sets may be defined by a software vendor according to industry groups, function groups and/or custom groups.

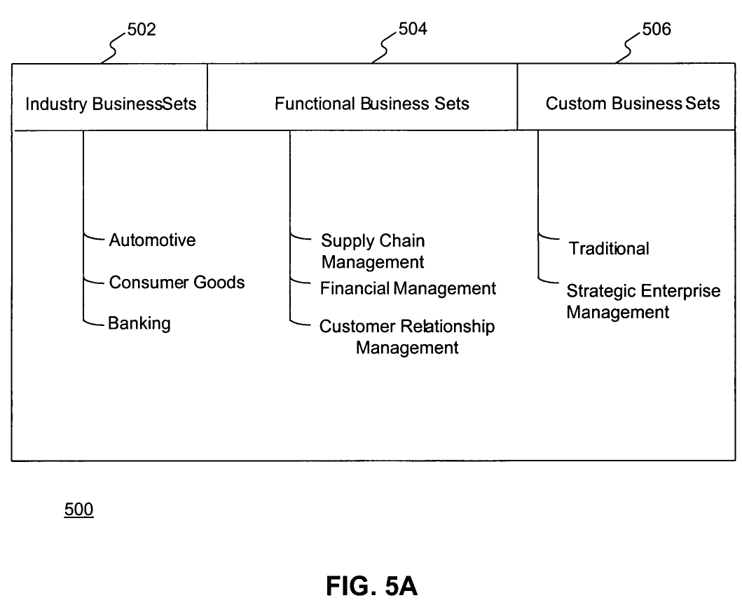

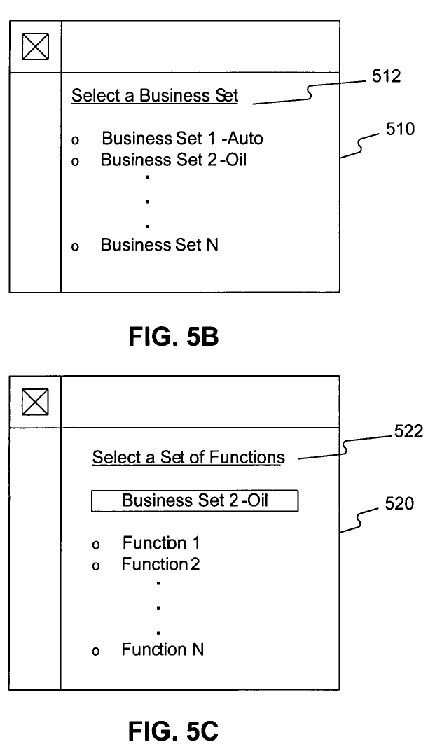

While not shown in FIGS. 4A and 4B, complex software system 200 may include an extension enabling layer and/or functionality similar to extension enabling layer 120 for enabling extensions and/or enabling selected functionality and/or features from a business set. Business sets may comprise industry-specific business sets, functional business sets, and/or custom business sets (see, for example, FIG. 5A). Industry business sets may relate to extensions for specific industry groups, such as automotive, consumer goods, or banking. Functional business sets may relate to extensions for specific functional groups, such as supply chain management, financial management, or customer relations management. Custom business sets may relate to custom configurations of complex software system 100, such as traditional or strategic enterprise management configurations.

In one embodiment, a user may select a business set, such as business set #1, business set #2, . . . or business set #n. Further, after a user selects a business set, then the user may select specific functionality and/or features that are grouped or associated with that selected business set. This approach can provide a controlled and/or guided process for user selection and, ultimately, configuration of the software.

As shown in FIG. 4B, selected business sets and functions from that business set, can result in modifications in one or more layers of system 200. Thus, if the user selects business set #1 and certain functions within that business set, functionality and/or features related to industry extensions 220 may be impacted (e.g., enabled and disabled). If the user selects business set #2 and certain functions within that business set, then modifications may result not only to industry extensions 220, but also to set of extensions 110 depending on the specific functions and features that are selected. As represented by business set #n in the example of FIG. 4B, the user selection may also impact items and features further down in system 200, such as in core layer 130. Alternatively, it may be desirable that core layer 130 does not change regardless of what business sets and functions are selected.

FIGS. 5A-C illustrate exemplary interfaces for receiving user selections to configure software, consistent with embodiments of the invention.

Specifically, FIG. 5A is a schematic illustration of an exemplary user interface 500 for configuring complex software system 200. As shown in the figure, using a pull down menu or some other graphical user interface element (provided by an extension enabling layer or similar logic, for example), a user may access and select functions (functionality and/or features) based on one or more groups of business sets, such as industry business sets 502, functional business sets 504, or custom business sets 506. Industry business sets 502 may relate to extensions for specific industry groups, such as automotive, oil and gas, consumer goods, or banking. Functional business sets 504 may relate to extensions for specific functional groups, such as supply chain management, financial management, or customer relations management. Custom business sets 506 may relate to custom configurations of complex software system 200, such as traditional or strategic enterprise management. A business set from any of these groups of business sets may be selected by a user using any combination of graphical user interface elements, such as radio buttons, pull down lists, checkboxes, input/output fields, push buttons, tab-strip control, sub-screen area, table control, custom control, status icon, etc.

FIG. 5B shows another exemplary user interface 510 for selecting a business set, consistent with an embodiment of the invention. In this example, a single grouping of business sets are presented to the user, such as industry business sets including Business Set 1-Auto, Business Set 2-Oil, etc. By choosing an option under Select a Business Set 512, the user can select a specific business set. Descriptions for each of the presented business sets may be provided for the user to facilitate the selection. Descriptions may be displayed or otherwise provided through a link, a reply email or otherwise upon request.

As shown by the exemplary user interface 520 of FIG. 5C, once the user selects a business set (e.g., through an interface such as in FIG. 5A or 5B), the user may then select a set of functions associated with the selected business set. This may be achieved, for example, by choosing an option under Select a Set of Functions 522. For example, if the user selected a Business Set 2 related to the oil industry, a number of Functions 1,2, . . . n, may be listed for selection by the user. Depending on the user selection, the software may then be configured and offered to the user. Similar to the descriptions for the business sets, descriptions for functions may also be provided to aid the user in making his/her selection.

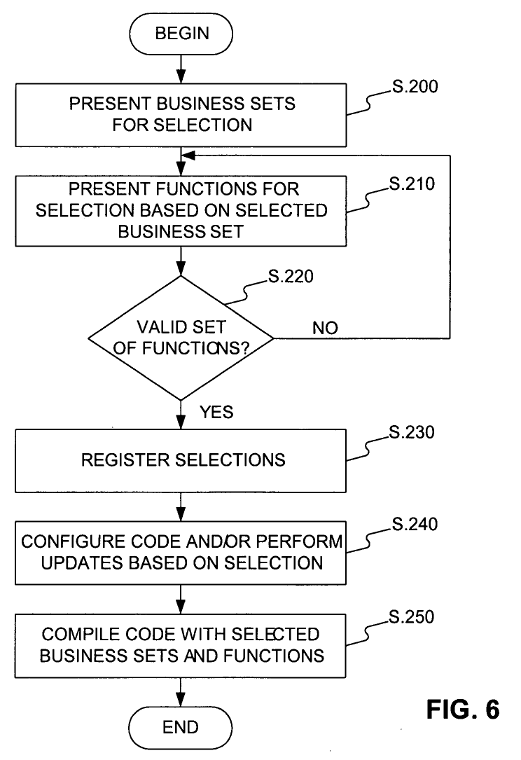

FIG. 6 is a flow chart of an exemplary method for configuring and offering software to a user, consistent with an embodiment of the present invention. The exemplary method of FIG. 6 may be applied to offer any type of software, including complex software 200 of FIGS. 4A and 4B. Further, in accordance with an aspect of the invention, the method of FIG. 6 may be automated by using a software component, such as an enabling layer and/or configuration module.

In step S.200, business sets may be presented to the user for selection. In one embodiment, a user may be presented the selection of business sets using a graphical user interface, such as interface 500 (FIG. 5A) or interface 510 (FIG. 5B). Thus, the user may select a business set from groupings of industry business sets, functional business sets, or custom business sets (see, for example, FIG. 5A). Alternatively, the user may be able to select a business set from a specific group of business sets, such as a business set for a group of industry business sets (see, for example, FIG. 5B).

Next, the user may be presented with a list of functions (functionality and/or features) for selection based on the selected business set (step S.210). Available selections may be presented using a graphical user interface, similar to exemplary user interface shown in FIG. 5C. One skilled in the art will appreciate that any graphical user interface and/or other techniques (e.g., email, orally via telephone, etc.) may be used to present functions for user selection.

Next, a configuration module or similar logic may determine whether the user selection of functions is valid (step S.220). In one embodiment, this step may include detecting any conflicts among the selected functions. Conflicts may be detected by applying logic or a suitable algorithm. In one embodiment, one or more tables may be accessed that indicate permissible combinations of functions. Conflicts between selected functions may relate to, for example, incompatible or unsupported combinations of functions or logic. Invalid function selections may also arise if it is determined that any two selected functions may result in, for example, attempts to modify or call the same data or system components at substantially the same time. In one embodiment, such conflicts may be known or determined based on the analysis of various configurations of industry extensions 220, etc.

If the selection of functions is determined not to be valid (step S.220; No), then the process may return to step S.210 where the user is again prompted to make a selection. As part of this step, the user may be informed of his/her selection was determined to be invalid. Additionally, or alternatively, in one embodiment, at least one alternative or additional function may be proposed to the user, such that the conflict among the functions can be resolved by selecting that function.

If the user selection is determined to be valid (step S.220; Yes), then processing may continue. In step S.230, the user-selected business set and functions may be registered or otherwise recorded. In one embodiment, the user-selected business set and functions may be registered with a reporting agent, which may keep track of the user-selected business sets and functions for pricing purposes, for example.

In step S.240, a configuration module or similar logic may configure and/or perform updates to the source code based on the user-selected business set and combination of functions. Thus, for example, tables and/or other data storage elements may be updated to configure the original source code according to the user selections. Such updates may be made to activate functions and/or features selected by the user. As described above, updates may be required throughout the code for one or more layers of the complex software system 200.

Thereafter, in step S.250, the configured source code may be compiled to generate a user-specific system. In one embodiment, only the selected functionality and/or features may be operable and the remaining functions in the extension layer 220 and elsewhere may not be made operable in the software shipped to the user. Thus, once configured and shipped to the user, the user may not access or use unselected functionality or features. In such case, a configuration module or other logic may keep track of unselected and selected functions and prevent the user from accessing certain functionality and/or features.

In accordance with one embodiment of the invention, a user may be permitted to change the selection of functions after delivery of the software. For example, after the user-specific system has been shipped to the user, the user may be able to request additional functions from a business set. For this purpose, the reporting agent may keep track of such requests and based on a pre-agreed policy, the source code may be reconfigured and compiled so that the newly selected functions are activated once the user has paid for them.

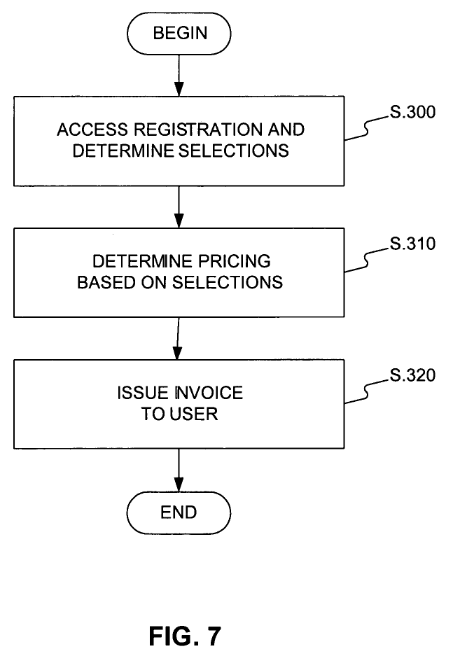

FIG. 7 is a flow chart of another exemplary method for pricing software, consistent with an embodiment of the present invention. The embodiment of FIG. 7 may be used in combination with the exemplary process of FIG. 6 to determine pricing after configuring the user-specific system.

In step S.300, the user-selected business set and functions are detected. This may be performed by accessing, for example, a registration table or other database table(s) containing information on the selected business set and functions. A pricing module may be provided which, when executed by a computer, may provide the functionality corresponding to step S.300 as well as steps S.310 to S.320. Thus, for example, the pricing module may access one or more database tables keeping track of the user's selections (recorded as part of step S.230 of FIG. 6, for example) and then determine a price for the user-specific system. In one embodiment, the price for the user-specific system, such as complex software system 200 may be generated by combining a base price for core layer 130 with a certain price for the user-selected business set and functions. The price for core layer 130 may depend on the number of users that will be using complex software system 200, for example. The price for the selected business set and functions may be based on the number of users who will be using the selected business set and functions concurrently, for example. In this manner, the user would pay for only the functionality and/or features that the user desires, even though complex software system 200 may be shipped with additional, inactive functionality or features, for example.

In one embodiment, subsequent to the purchase of complex software system 200, the user may order additional functions, request that certain functions be deleted or otherwise alter the business set and function selection. For example, upon receiving a request from a user, the software vendor may remotely activate additional business set(s) and/or related functionality, after receiving a payment from the user for the additional business set(s) and/or related functionality, for example. In one embodiment, an administrator code, password or key and/or user interface similar to that shown in FIGS. 5A-C, may be used by the software vendor to activate the selected business set(s) and/or related functionality. One skilled in the art will appreciate that activation commands may be communicated locally or remotely to complex software system 200 through a network (not shown), such as the Internet. In one embodiment, a configuration module (not shown) may receive the activation commands and re-configure the business set(s) and/or related functionality, so that the user has access to the additional business set(s) and/or functions.

In the above-described embodiments, business sets may be mutually exclusive. That is, the user may only select one business set at any given time. This can result in greater control over the selection process and provide greater stability for the core and other layers of system 200. Alternatively, the user may be permitted to select more than one business set. In such a case, the validity of the combination of business sets selected may be determined, in a similar fashion to that described for checking the validity of selected functions.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and flow charts of this invention are within the skill of an experienced developer. The various programs or program modules can be created using any of the techniques known to one skilled in the art or can be designed in connection with existing software. For example, programs or program modules can be designed in or by means of Java, C++, HTML, XML, or HTML with included Java applets or in SAP R/3 or ABAP. One or more of such modules can be integrated in existing e-mail or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

Accordingly, other embodiments of the invention will be apparent to those skilled in the art from consideration of the specification and practice of the invention disclosed herein. It is therefore intended that the specification and examples be considered as exemplary only, with a true scope and spirit of the invention being indicated by the following claims.

1. A method for configuring software, the software comprising a core and plurality of user selectable extensions, the method comprising:
presenting a plurality of extensions for selection by a user;
determining whether the user selection of extensions is valid;
configuring, if the user selection of extensions is determined to be valid, source code for the software based on the selection of extensions; and
compiling the configured source code for the selected extensions and core to generate a user-specific system.

2. The method of claim 1, further comprising proposing at least one alternative extension for selection by the user, if the user selection of extensions is determined to be invalid.

3. The method of claim 1, wherein the validity of the user selection is processed using an extension enabling layer.

4. The method of claim 1, wherein the source code comprises performing updates to the source code in accordance with the extensions selected by the user.

5. The method of claim 1, further comprising registering the user selection of extensions in memory.

6. The method of claim 1, further comprising detecting the selection of extensions by the user and determining, based on the detected selection of extensions, a price for the user-specific system.

7. The method of claim 6, further comprising issuing an invoice to the user, wherein the invoice includes the determined price for the software.

8. A system for providing software, the software comprising a core and plurality of user selectable extensions, the system comprising:
means for presenting a plurality of extensions for selection by a user;
means for determining whether the user selection of the extensions is valid; and
means for configuring code for the software based on the selected extensions when the user selection is determined to be valid.

9. The system of claim 8, further comprising means for proposing at least one alternative extension for selection by the user, if the user selection of extensions is determined to be invalid.

10. The system of claim 8, wherein the means for configuring code for the software comprises means for configuring, if the user selection of extensions is determined to be valid, source code for the software based on the selection of extensions.

11. The system of claim 10, wherein the means for configuring code for the software further comprises means for compiling the configured source code for the selected extensions to generate a user-specific system.

12. The system of claim 8, further comprising means for registering the user selection of extensions in memory.

13. The system of claim 8, further comprising means for detecting selection of extensions by the user and means for determining a price for the user-specific system based on the user selection of extensions.

14. The system of claim 13, further comprising means for issuing an invoice to the user, the invoice comprising the determined price for the software.

15. A method for providing software to a user, the method comprising:
presenting a plurality of business sets for selection by a user;
presenting, based on a business set selected by the user, a plurality of functions for selection by the user;
determining whether the user selection of functions is valid; and
if the user selection of functions is determined to be valid, configuring code for the software based on the selected business set and functions.

16. The method of claim 15, wherein configuring code for the software comprises performing updates based on the user selection to source code for the software and compiling the updated source code to generate a user-specific system.

17. The method of claim 15, further comprising registering the user-selected business set and functions in memory.

18. The method of claim 17, further comprising accessing registration information for the user-selected business set and functions and determining a price for the user-specific system based on the user-selected business set and functions.

19. The method of claim 18, wherein determining a price comprises applying a pricing model, the pricing model including a base price for a core of the software and an additional price for the user-selected functions.

20. A system for configuring software for a user, the system comprising:
means for presenting a plurality of business sets for selection by a user;
means for presenting, based on a business set selected by a user, a plurality of functions for selection by the user, the plurality of functions corresponding to enhancements to the software;
means for determining whether the user selection of functions is valid; and
means for performing, if the user selection is determined to be valid, updates to code to the software based on the functions selected by the user.

21. The system of claim 20, wherein the means for performing updates comprises means for configuring source code based on the user selection of functions and means for compiling the configured source code to generate a user-specific system.

22. The system of claim 20, further comprising means for detecting the functions selected by the user and means for determining a price for the software based on the user selection of functions.

23. The system of claim 22, wherein the means for determining a price comprises means for applying a pricing model to determine the price for the software based on the user-selected functions.

24. The system of claim 23, wherein the pricing model includes a base price for a core of the software and an additional price for the user-selected functions.
